(19) United States
(12) Patent Application Publication
(10) Pub. No.: US 2006/0065020 A1
(43) Pub. Date: Mar. 30, 2006

(54) Molding core

(75) Inventor: Jui-Fen Pai, Taichung (TW)

Correspondence Address: PILLSBURY WINTHROP SHAW PITTMAN, LLP, P.O. BOX 10500, MCLEAN, VA, 22102, US

(73) Assignee: ASIA OPTICAL CO., INC., Taichung (TW)

(21) Appl. No.: 11/225,007

(22) Filed: Sep. 14, 2005

(30) Foreign Application Priority Data
Sep. 27, 2004 (TW) 093129224

(51) Int. Cl. C03B 11/08

(52) U.S. Cl. 65/374.11; 65/374.12; 65/374.15

(57) ABSTRACT

A molding core includes: a substrate having a roughened article-shaping surface; and a hard coating formed on the roughened article-shaping surface of the substrate and including a protective film that comprises a metal complex of carbon and at least one noble metal selected from the group consisting of Pt, Ir, Ru, Re, Rh, Ta, and Os. The protective film has a thickness greater than 5 μm so as to increase the number of times that the protective film can be repaired. Combination of the noble metal and carbon can prevent the noble metal of the protective film from reacting with carbon of a diamond tool during turning process.

### CROSS-REFERENCE TO RELATED APPLICATION

This application claims priority of Taiwanese Application No. 093129224, filed on Sep. 27, 2004.

### BACKGROUND OF THE INVENTION

1. Field of the Invention

This invention relates to a molding core, more particularly to a molding core with a hard coating having a protective film that can be repaired using single point diamond turning machining.

2. Description of the Related Art

JP63-103836 discloses a molding core with an Ir—Re—C protective film formed on a tungsten carbide substrate. The introduction of carbon in the noble metal-based protective film can inhibit undesired grain growth of the noble metals of the protective film under a high molding temperature in a molding process. The molding core is prepared by grinding the substrate so as to form a smooth surface with a high precision, and subsequently forming a relatively thin layer (2 μm thickness) of the protective film on the smooth surface so that a smooth surface of the protective film with a high precision can be achieved for the protective film. Since the substrate is made from tungsten carbide, the same is extremely hard, and it is thus time-consuming and troublesome to form the smooth surface by grinding. In addition, since the surface of the substrate is very smooth, the protective film tends to peel from the substrate when the thickness of the protective film exceed 2 μm. Furthermore, with a thickness of 2 μm or less, the protective film cannot be finished or repaired using a diamond cutter which is likely to cut through the protective film and undesirably contact the substrate during finishing or repairing, thereby damaging the diamond cutter.

JP06-144850 discloses a molding core with a protective film of an amorphous noble metal formed on a tungsten carbide substrate. Since the hardness of the amorphous noble metal is less than that of tungsten carbide, the protective film can be subjected to single point diamond turning machining to form a smooth surface with a high precision for molding use. However, undesired grain nucleation and growth of the amorphous noble metal occurs when the protective film is exposed to a high molding temperature, which can result in thermal stress in the protective film and formation of cracks.

JP06-183755 discloses a molding core which differs from that of JP06-144850 in that the amorphous noble metal of the protective film is finished and is subsequently subjected to a thermal treatment so as to transform the noble metal from the amorphous state to a crystalline state. The protective film thus formed can eliminate the aforesaid grain growth under a high molding temperature in a molding process. However, during thermal treatment, the surface of the protective film will be undesirably roughened. As a consequence, the protective film is required to be polished prior to use in a molding process.

In addition, the protective films of JP06-144850 and JP06-183755 can cause chemical wear to a diamond turning tool due to reaction of carbon atoms of the diamond of the diamond turning tool with the noble metal of the protective film during the single point diamond turning machining, thereby reducing the service life of the diamond turning tool.

### SUMMARY OF THE INVENTION

The object of the present invention is to provide a molding core that is capable of overcoming the aforesaid drawbacks of the prior art.

According to one aspect of this invention, there is provided a molding core for a press-molding mold. The molding core comprises: a substrate having a roughened article-shaping surface; and a hard coating formed on the roughened article-shaping surface of the substrate and including a protective film that comprises a metal complex of carbon and at least one first noble metal selected from the group consisting of Pt, Ir, Ru, Re, Rh, Ta, and Os. The protective film has a thickness greater than 5 μm.

According to another aspect of this invention, there is provided a molding core for a press-molding mold. The molding core comprises: a substrate; and a hard coating formed on the substrate and including a protective film that comprises a metal complex of carbon, at least one first noble metal, and at least one second noble metal. At least one of the electrons in the outermost D orbit of the atom of the first noble metal is unpaired, and all of the electrons in the outermost D orbit of the atom of the second noble metal are paired.

### BRIEF DESCRIPTION OF THE DRAWING

Other features and advantages of the present invention will become apparent in the following detailed description of the preferred embodiments of the invention, with reference to the accompanying drawing, in which:

FIG. 1 is a schematic view of the preferred embodiment of a molding core according to this invention.

### DETAILED DESCRIPTION OF THE PREFERRED EMBODIMENTS

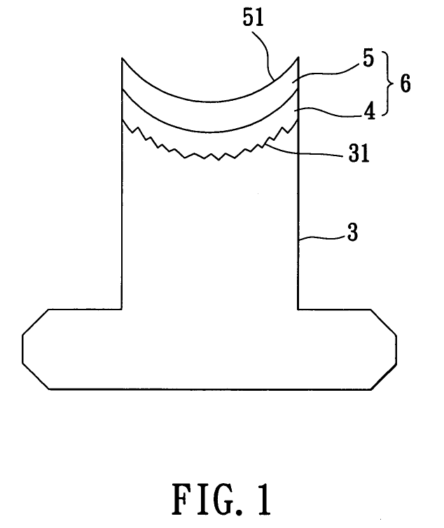

FIG. 1 illustrates the preferred embodiment of a molding core used in a press-molding mold (not shown) for making optical lens articles according to the present invention.

The molding core includes: a substrate 3 having a roughened article-shaping surface 31; and a hard coating 6 formed on the roughened article-shaping surface 31 of the substrate 3 and including a protective film 5 that comprises a metal complex of carbon and at least one noble metal selected from the group consisting of Pd, Au, Pt, Ir, Ru, Re, Rh, Ta, and Os. The protective film 5 has a thickness greater than 5 μm so as to increase the number of times that the protective film 5 can be repaired. The protective film 5 has a smooth surface 51 that is finished via single point diamond turning machining and that has a high precision for molding the optical lens articles.

It is noted that introduction of carbon into the noble metal-based protective film 5 permits elimination of the aforesaid chemical wear drawback associated with the prior art, and that the amount of carbon introduced in the metal complex depends on the combination of the noble metals.

Therefore, in this embodiment, the metal complex preferably comprises at least one first noble metal (i.e., Rh_{4d}⁸, OS_{5d}⁶, Ru_{4d}⁷, Ta_{5d}³, Re_{5d}⁵, Ir_{5d}⁷, and Pt_{5d}⁹) and at least one second noble metal (i.e., Pd_{4d}¹⁰ and Au_{5d}¹⁰) such that at least one of the electrons in the outermost D orbit of the atom of the first noble metal is unpaired, and that all of the electrons in the outermost D orbit of the atom of the second noble metal are paired. As such, since the first noble metal has an unsaturated electron in the outermost D orbit, the first noble metal can react with the carbon of the diamond tool to form the metal complex, thereby necessitating introduction of carbon into the noble metal-based protective film 5 to prevent the unpaired electrons in the outmost D orbit from reacting with the carbon of the diamond tool, while the second noble metal remains unchanged, thereby permitting a reduction in the amount of carbon required for forming the metal complex while maintaining effectiveness in preventing the aforesaid chemical wear from occurring.

Preferably, the first and second noble metals are crystalline so as to prevent the aforesaid grain growth associated with the prior art.

Preferably, the metal complex contains 10 to 50 wt % carbon, and more preferably, the metal complex contains 10 to 50 wt % carbon and up to 83 wt % of the second noble metal.

Preferably, the thickness of the protective film 5 ranges from 10 to 30 μm.

The hard coating 6 may further include an intermediate layer 4 that is sandwiched between the substrate 3 and the protective film 5. The intermediate layer 4 comprises a metal compound selected from the group consisting of a metal oxide, a metal nitride, and a metal carbide. The metal compound comprises at least one metal selected from the group consisting of Ti, Cr, Nb, Zr, Al, and Si.

Preferably, the metal compound is titanium nitride, and the intermediate layer 4 has a thickness ranging from 20 to 200 nm.

Preferably, the substrate 3 is made from tungsten carbide, or cermets which contain titanium nitride or titanium carbide. In this embodiment, the substrate 3 is made from tungsten carbide.

### EXAMPLE

This invention will now be described in greater detail with reference to the following Examples.

### Example 1

The substrate 3 employed in this Example is made from tungsten carbide. The intermediate layer 4 is made from titanium nitride, and has a thickness of 100 nm. The protective film 5 comprises Pd—Ru—Ta—C, and has a thickness of 20 μm. The weight ratio of Pd:Ru:Ta:C is 83:2:5:10. The intermediate layer 4 was formed on the roughened article-shaping surface 31 of the substrate 3 by sputtering techniques in a vacuum system. The protective film 5 was subsequently formed on the intermediate layer 4 by sputtering techniques in the vacuum system. Methane and argon gases were introduced into a sputtering chamber of the vacuum system in a mass flow rate ratio of 1:4 (CH₄:Ar). The sputtering was conducted using a Pd—Ru—Ta target (with a weight ratio Pd:Ru:Ta=81:4:15) under a working pressure of 15 mtorr. The protective film 5 was subjected to a thermal treatment through seating of the substrate 3 on a carrier heated to a temperature of 450° C. so as to crystallize the Pd—Ru—Ta noble metal, and was subsequently finished using single point diamond turning machining to form the smooth surface 51 with a high precision.

### Example 2

The substrate 3 employed in this Example is made from tungsten carbide. The intermediate layer 4 is made from titanium nitride, and has a thickness of 100 nm. The protective film 5 comprises Ir—Ru—C, and has a thickness of 20 μm. The weight ratio of Ir:Ru:C is 33:22:45. The intermediate layer 4 was formed on the roughened article-shaping surface 31 of the substrate 3 by sputtering techniques in a vacuum system. The protective film 5 was subsequently formed on the intermediate layer 4 by sputtering techniques in the vacuum system. Methane and argon gases were introduced into a sputtering chamber of the vacuum system in a mass flow rate ratio of 5:1 (CH₄:Ar). The sputtering was conducted using a Ir—Ru target (with a weight ratio Ir:Ru=62:38) under a working pressure of 10 mtorr. The protective film 5 was subjected to a thermal treatment through seating of the substrate 3 on a carrier heated to a temperature of 650° C. so as to crystallize the Ir—Ru noble metal, and was subsequently finished using single point diamond turning machining to form the smooth surface 51 with a high precision.

### Example 3

The substrate 3 employed in this Example is made from tungsten carbide. The intermediate layer 4 is made from titanium nitride, and has a thickness of 100 nm. The protective film 5 comprises Ir—Re—C, and has a thickness of 20 μm. The weight ratio of Ir:Re:C is 45:5:50. The intermediate layer 4 was formed on the roughened article-shaping surface 31 of the substrate 3 by sputtering techniques in a vacuum system. The protective film 5 was subsequently formed on the intermediate layer 4 by sputtering techniques in the vacuum system. Methane and argon gases were introduced into a sputtering chamber of the vacuum system in a mass flow rate ratio of 6:1 (CH₄:Ar). The sputtering was conducted using a Ir—Re target (with a weight ratio Ir:Re=89:11) under a working pressure of 10 mtorr. The protective film 5 was subjected to a thermal treatment through seating of the substrate 3 on a carrier heated to a temperature of 650° C. so as to crystallize the Ir—Re noble metal, and was subsequently finished using single point diamond turning machining to form the smooth surface 51 with a high precision.

Since Pd has an even number of electrons in the outermost D orbit and is a dominant component of the metal complex Pd—Ru—Ta—C, the amount of carbon required to form the metal complex is much less than those of Examples 2 and 3.

By introducing carbon in the noble metal-based protective film 5, the aforesaid undesired grain growth and the chemical wear associated with the prior art can be eliminated. By increasing the thickness of the protective film 5, the repair times for the protective film 5 can be increased. Furthermore, by roughening the surface of the substrate 3, the thickness of the protective film 5 can be increased without causing the aforesaid peeling problem associated with the prior art.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A molding core for a press-molding mold, comprising:
a substrate having a roughened article-shaping surface; and
a hard coating formed on said roughened article-shaping surface of said substrate and including a protective film that comprises a metal complex of carbon and at least one first noble metal selected from the group consisting of Pt, Ir, Ru, Re, Rh, Ta, and Os;
wherein said protective film has a thickness greater than 5 μm.

2. The molding core of claim 1, wherein said metal complex contains 10 to 50 wt % carbon.

3. The molding core of claim 2, wherein said metal complex comprises Ru and Ta.

4. The molding core of claim 3, wherein said metal complex further comprises at least one second noble metal that is selected from the group consisting of Pd and Au.

5. The molding core of claim 4, wherein said second metal complex is Pd.

6. The molding core of claim 2, wherein said metal complex comprises Ru and Ir.

7. The molding core of claim 2, wherein said metal complex comprises Ir and Re.

8. The molding core of claim 1, wherein the thickness of said protective film ranges from 10 to 30 μm.

9. The molding core of claim 1, wherein said hard coating further includes an intermediate layer that is sandwiched between said substrate and said protective film, said intermediate layer comprising a metal compound selected from the group consisting of a metal oxide, a metal nitride, and a metal carbide, said metal compound comprising at least one metal selected from the group consisting of Ti, Cr, Nb, Zr, Al, and Si.

10. The molding core of claim 9, wherein said metal compound is titanium nitride.

11. The molding core of claim 9, wherein said intermediate layer has a thickness ranging from 20 to 200 nm.

12. The molding core of claim 1, wherein said substrate is made from tungsten carbide.

13. A molding core for a press-molding mold, comprising:
a substrate; and
a hard coating formed on said substrate and including a protective film that comprises a metal complex of carbon, at least one first noble metal, and at least one second noble metal;
wherein at least one of the electrons in the outermost D orbit of the atom of said first noble metal is unpaired, and all of the electrons in the outermost D orbit of the atom of said second noble metal are paired.

14. The molding core of claim 13, wherein said metal complex contains 10 to 50 wt % of carbon.

15. The molding core of claim 14, wherein said metal complex contains up to 83 wt % of said second noble metal.

16. The molding core of claim 13, wherein said metal complex comprises Ru and Ta as said first noble metal, and Pd as said second noble metal.

17. The molding core of claim 13, wherein said hard coating further includes an intermediate layer that is sandwiched between said substrate and said protective film, said intermediate layer comprising a metal compound selected from the group consisting of metal oxide, metal nitride, and metal carbide, said metal compound comprising at least one metal selected from the group consisting of Ti, Cr, Nb, Zr, Al, and Si.

18. The molding core of claim 17, wherein said metal compound is titanium nitride.

19. The molding core of claim 17, wherein said intermediate layer has a thickness ranging from 20 to 200 nm.

20. The molding core of claim 13, wherein said substrate is made from tungsten carbide.
